(19) United States
(12) Patent Application Publication
(10) Pub. No.: US 2019/0016021 A1
(43) Pub. Date: Jan. 17, 2019

(54) APPARATUS FOR CURING A TUBULAR LINER

(71) Applicant: SML Verwaltungs GmbH, Rohrbach (DE)

(72) Inventors: Christian NOLL, Limburgerhof (DE); Herbert WIND, Alsbersweiler (DE)

(21) Appl. No.: 15/767,712

(22) PCT Filed: Oct. 12, 2016
(86) PCT No.: PCT/EP2016/074522

§ 371 Date: Sep. 27, 2018

(30) Foreign Application Priority Data
Oct. 13, 2015 (DE) 10 2015 117 372.7

(51) Int. Cl. B29C 35/08; F16L 55/165; B29C 63/34; F16L 55/40; B29C 35/00

(52) U.S. Cl. CPC B29C 35/0805; F16L 55/165; B29C 63/34; B29L 2023/006; B29C 35/002; B29C 2035/0827; F16L 55/40

(57) ABSTRACT

The present invention relates to an apparatus for curing resin-impregnated tubular liners by means of high-energy radiation, comprising at least two radiation sources for producing high-energy radiation, wherein the apparatus has a front end, a rear end opposite the front end, two opposite side ends, an upper end and a lower end opposite the upper end, wherein a length of the apparatus, measured from the front end to the rear end, a width of the apparatus, measured from a side end to the opposite side end, and/or a height of the apparatus, measured from the lower into the upper end, is smaller in a transport state than in an operating state, in that at least one element of the apparatus is mounted such that the element can be folded out, displaced, rotated, and/or moved, and wherein at least one further radiation source is arranged to be spaced further apart from at least one further radiation source when in the operating state than in the transport state. The invention further relates to a use of such an apparatus.

The present invention relates to an apparatus for curing a tubular liner.

Methods for restoring piping systems in which liquid or gaseous media, for example, are transported are known in the prior art and frequently described.

For example, methods are known in which defective or damaged sections of the piping system are replaced with new sections. However, this is laborious and also not always possible.

Methods in which for the restoration of piping systems, e.g. channels and similar tube systems, a flexible, hardenable resin-impregnated curable layer, referred to as a tubular liner, or liner, is inserted into the piping system are further known in the prior art. After the insertion, the tubular liner is widened so that it fits tightly on the inner wall of the piping system. The resin is then cured.

The production of such tubular liners is described in WO 95/04646, for example. Such a tubular liner usually comprises an optically opaque outer film, an inner film that is transparent to electromagnetic radiation at least for certain wavelength ranges, as well as a curable layer impregnated with resin, which is arranged between the inner film and the outer film.

The outer tubular film should prevent the resin used for impregnation from escaping from the curable layer and being released into the environment. This requires a good tightness and connection of the outer film tube to the resin-impregnated curable layer.

A tubular liner is known from WO 00/73692 A1 comprising an inner film tube, a resin-impregnated fiber band as a curable layer and an outer tube which is clad with a fiber fleece on its inner side.

Often, the resin-impregnated fiber band is wound helically and overlapping on the inner tube of a tubular liner for its manufacture. The outer tube is then also wound helically and overlapping around the resin-impregnated fiber band. In the prior art, unsaturated polyester resins or vinyl ester resins are used as curable resins which, for example, can be dissolved in styrene and/or an acrylic ester. These unsaturated polyester or vinyl esters can be cured thermally (usually by means of peroxide catalysts) or by means of radiation, e.g. by means of UV light with photoinitiators, as described in EP-A 23623, for example. So-called combination curings with a peroxide initiator used for thermal curing in combination with photoinitiators are also possible and have proven to be particularly advantageous for large wall thicknesses of tubular liners. A method for such a so-called combination curing is described in EP-A 1262708, for example. Unsaturated polyester or vinyl ester resins are subject to shrinkage during curing, which can impair the stability of the restored piping system in later operation.

The inner tube itself is also wound around a winding spindle for ease of manufacture. Alternatively, WO 95/04646, for example, discloses that a prefabricated inner film tube is inflated and can itself serve as a winding spindle. Such a prefabricated inner film tube is manufactured from a film band, the film edges of which are joined together by welding or gluing to form the inner film tube.

Before curing, the tubular liner is inserted into the piping system to be restored and inflated by means of a fluid, generally compressed air. For inflation of the tubular liner, an opening end of tubular liner according to the prior art is charged with air and the opposite opening end of the tubular liner is closed with a closing apparatus, a so-called packer. This closing apparatus comprises a hollow cylinder and a cover element with which the hollow cylinder can be closed.

A curing apparatus, which comprises a radiation source and which is guided through the curing tube, is introduced into the lining tube to cure it to activate or carry out curing of the curable layer of the tubular liner with the radiation energy.

Curing apparatuses known from the prior art have the disadvantage that the curing apparatus must be inserted into the tubular liner before it is closed and inflated. In the uninflated state, the tubular liner is stretched over the packer. From there, the tubular liner slopes downward until it lies double-walled on the floor of the piping to be restored. However, no curing apparatus can be positioned within this sloping course of the tubular liner so that the curing apparatus is protected from damage, as the tubular lining does not lie on this, even in the inflated state. Thus, the tubular line, which can have a high weight, at least partially lies on the curing device until the tubular liner is inflated by the compressed air.

Due to the lying of the tubular lining on the curing apparatus, it can be damaged. The necessary repair work on the curing apparatus results in high costs and a long-time delay, as this must first be removed at least again from the tubular liner.

Widening of the packer for providing protection against the tubular liner lying on the curing apparatus is not sufficient for this and there are technical limits. On the one hand, the packer must be brought into the piping to be restored through the relatively narrow manhole so that larger widths are impeded. On the other hand, packers already have a very high weight, especially in the case of piping with larger diameters, which would be further increased through a widening of itself.

The length of the curing apparatus cannot be also technically reduced arbitrarily. The radiation sources have a predefined length and/or width or a predefined diameter. Therefore, due to the radiation sources themselves, a minimum length of the curing apparatus is predefined. Furthermore, it is necessary for curing of the tubular liner that at least two radiation sources or arrangements of radiation sources are displaced from one another, subsequently carried out by piping to be restored brought into the tubular liner.

Consequently, the object of the present invention was to overcome the disadvantages of the prior art, and in particular to deliver an apparatus which is not damaged by a tubular liner that in not yet inflated.

This object is in particular achieved by means of an apparatus for curing resin-impregnated tubular liners with high-energy radiation, comprising at least two radiation sources for producing high-energy radiation, wherein the apparatus has a front end, a rear end opposite the front end, two opposite side ends, an upper end and a lower end opposite the upper end, wherein a length of the apparatus, measured from the front end to the rear end, a width of the apparatus, measured from a side end to the opposite side end, and/or a height of the apparatus, measured from the lower into the upper end, is smaller in a transport state than in an operating state, in that at least one element of the apparatus is mounted such that the element can be folded out, displaced, rotated, and/or moved, and wherein at least one further radiation source is arranged to be spaced further apart from at least one further radiation source when in the operating state than in the transport state.

The tubular liner stretched over the packer in the uninflated state slopes downward until it lies double-walled on the floor of the piping to be restored. The smaller in dimensions transport state of the apparatus according to the invention in comparison to the dimensions in the operating state make it possible that this can be positioned or is positioned completely within this sloping course, for example in that the apparatus according to the invention is arranged completely in the said area of the tubular liner or partially on the packer and partially in the tubular liner. Thus, the apparatus is protected from damage, as the tubular liner does not lie on the apparatus from above. The necessary distance of the radiation sources is thus ensured in the operating state in that the radiation sources are positioned further from one another than in the transport state. Thus, it is obvious to the person skilled in the art that the terms length, width, height purely serve for ease of understanding of the present invention. A length of the apparatus according to the invention can also be a width, a height, a length, etc.

In the sense of the present invention, piping systems should be understood as piping systems for any type of transport of liquid or gaseous media, which can be operated at reduced pressure, normal pressure or overpressure. For example, pipelines of any type, pipeline systems for transporting media in chemical plants and production facilities, pressure lines such as compressed water pipes and drinking water pipes and in particular also waste water systems are listed here, which are laid underground or not visible. The use of the light source according to the invention for curing of tubular liners is in particular also suited for the restoration of such waste water pipes in sewer systems.

According to the invention, it can be provided that a gas discharge lamp, a short-arc lamp, a stroboscopic lamp, a flash lamp, an arc lamp, in particular a xenon lamp, and/or a mercury xenon lamp is used as a radiation source, wherein in particular the light source provides or can provide at least fifty percent (50%) of the radiation energy in a wavelength range of 351 to 800 nm, in particular in a range of 380 nm to 800 nm, in particular in a range of 380 nm to 700 nm, preferably in a range of 390 nm to 470 nm, or in a range of 400 nm to 800 nm.

Tubular liners generally comprise one or a plurality of fiber bands as curable and/or cured layers which are impregnated with a hardenable resin. Generally, all of the products known to the person skilled in art in woven, knitted, laid, mat or non-woven forms which may contain fibers in the form of long filaments or short fibers are suited as fiber bands. Corresponding products are known per se to the person skilled in the art and commercially available in great variety from various manufacturers. Such tubular liners can be optimally cured with radiation sources according to the invention.

In the scope of the present invention, felts should also be understood as fiber bands in the sense of the invention. A felt is a fabric of a disordered, difficult to separate fiber material. In principle, felts are thus non-woven textiles. Felts are generally produced from chemical fibers and vegetable fibers by dry needling (so-called needle felting) or by solidification with high-pressure water jets from nozzle bars. The individual fibers in felt are wound in a disordered way in relation to one another. Felts have a good temperature resistance and are generally moisture-repellent, which can be an advantage when used in systems carrying liquid.

The length of the fibers used is not subject to any particular restriction, i.e. both so-called long fibers and short fibers or fiber fragments can be used. Over the length of the fibers used the properties of the corresponding fiber bands can be adjusted and controlled over a wide range.

The type of the fibers used is also not subjected to any restriction. Only glass fibers, carbon fibers or plastic fibers such as aramid fibers or fibers made of thermoplastics such as polyesters or polyamides or polyolefins (e.g. polypropylene) are listed here as examples, which are known to the person skilled in the art with their properties and are commercially available in great variety. For economic reasons, generally glass fibers are preferred; however, if specific heat resistance is important, for example, aramid fibers or carbon fibers, for example, can be used which can provide advantages in relation to strength at higher temperatures compared to glass fibers.

Tubular liners can have one or a plurality of fiber bands, which can also be the same or different. Further suitable combinations of a plurality of fiber bands are described in WO 201 1/006618, to which reference is made in full at this point. WO 2003/038331 also describes fiber bands or continuous materials with a suitable structure.

According to the invention, it can be provided that at least one first securing device and at least one second securing device is included, wherein the at least one first securing device is connected or can be connected to the at least one second securing device by means of at least one telescopic arm, or the at least one first securing device is connected or can be connected to a first end of at least one connecting device by means of at least one telescopic arm, and the at least one second securing device is connected or can be connected to a second end opposite to the first end of the connecting device by means of at least one further telescopic arm, so that the at least one first connecting device and the at least one second connecting device can be displaced relative to one another, and in particular relative to the connecting device, preferably displaced in a linear way.

Through a connection according to the invention of the at least two securing devices by means of at least one telescopic arm, it can be possible that the length of the apparatus can be varied by simple means, in particular by means of linear displacement of the securing devices relative to one another. In the operating state, the telescopic arm is extended, in the transport state it is retracted. The length of the telescopic arm extension thus makes is possible to adjust the length of the apparatus according to the invention. The use of at least two telescopic arms is made possible by means of the connecting device according to the invention. Thus, the at least one connecting device and the at least one second connecting device can be extended and retracted independently of one another, or simultaneously.

In addition, the connecting device facilitates in particular a doubled stroke length and therefore a doubled increase in the length of the apparatus according to the invention. This can, for example, be realized in that the two telescopic arms are arranged displaced parallel to one another in the connecting device.

According to the invention, it can also be provided that at least one first radiation source, in particular n radiation sources, where n=1, 2 3, 4, 5, 6, 7, 8, 9, 10, or more, is arranged on the first securing device and at least one additional radiation source, in particular m additional radiation sources, where m=1, 2 3, 4, 5, 6, 7, 8, 9, 10, or more, is arranged on the second securing device.

The amount of radiation sources can be adjusted to the type and the construction, as well as the diameter of the radiation sources in order to facilitate optimal curing of the tubular liners.

Furthermore, it can be provided that the radiation sources are arranged spaced at a first distance from the first and/or second securing apparatus, in particular n,m radiation sources are displaced circularly around the first and/or the second securing device, arranged displaced about a center angle α of the first and/or second securing device of 15, 20, 30, 45, 60, 90, or 120° with respect to one another, preferably each of the 3 radiation sources are arranged displaced about a center angle α of 120° on the at least one first and the at least one second securing device.

Through a circular arrangement according to the invention of the radiation sources around the at least one first and/or second securing device it can be possible that a complete curing of the tubular liners is achieved. An arrangement of three radiation sources each displaced at 120° has proved to be advantageous.

It can also be preferable that the radiation sources are connected or can be connected at a fixed distance from the at least one first and/or the at least one second securing device to these by means of spacer elements or these are arranged so that they can be folded out, displaced, rotated, and/or moved relative to the at least one first and/or the at least one second securing device by means of spacer elements, in particular by means of telescopic spacer elements.

It has been shown that the radiation sources are connected to the apparatus according to the invention at an optimum distance for the respective diameter of the tubular liner by means of spacer elements, for example bar-shaped spacing elements. Alternatively, it can be advantageous for variable use of the apparatus according to the invention without set-up time that the radiation sources are connected to the first and/or the second securing device with variable spacer elements. This can in particular be carried out by means of telescopic spacer elements which make linear displacement of the radiation sources possible.

According to the invention, it is also preferable that at least one, in particular all radiation sources of the at least one first securing device and the at least one second securing device are arranged displaced from one another about a center angle β, so that in the transport state these are arranged or can be arranged at least in sections, in particular parallel, overlapping.

Such a displaced arranged of the radiation sources has in particular the advantage that the radiation sources of the at least one first securing device and the at least one second securing device do not block or impede each other or the apparatus according to the invention when it starts. Thus, the problem is solved that the outer dimensions of the apparatus according to the invention are determined by the double length of a radiation source used, but the apparatus according to the invention corresponds minimally in its length to the length of a selected radiation source.

It can also be provided that the at least one first securing device and/or the at least one second securing device comprise at least one, in particular o, where o=1, 2 3, 4, 5, 6, 7, 8, 9, 10, or more, wheels, wherein at least one, in particular each of the wheels is connected or can be connected to and spaced from the at least one first and/or the at least one second securing device by means of a spacer element, wherein in particular the distance of at least one, in particular all of the wheels from the first and/or second securing device in the transport state is less than in the operating state.

Moving on rollers has proved to be advantageous for a movement of the apparatus according to the invention in a tubular liner. Thus, rollers lie on the inner wall of the tubular liner. It is particularly advantageous if there are four rollers, both on the first and also the second securing device. According to one embodiment, wheels with three rollers which are arranged so as to be rotatable about a central axis, may be particularly suitable. Through use of the said three rollers it is possible that a height offset within the tubular liner can also be easily overcome. Such a height offset can occur through a coupling offset or a fold.

Thus, according to an embodiment of the invention it can be advantageous that the support elements are formed in a circular ring segment shape and can be inserted into a passed through a storage device arranged on each one of the at least one first and/or second securing device and/or formed by these, wherein the support elements are arranged displaced about a center angle γ of the first and/or second securing device of 15, 20, 30, 45, 60, 90, or 120° in relation to one another, preferably each of the 4 support elements are displaced about a center angle γ of 90°, on the at least one first and/or the at least one second securing device.

Through such a circular segment-shaped formation of the support elements it can be possible that the apparatus according to the invention is compact in the transport state. In addition, the formation according to the invention of the support elements that the wheels of the at least one first and/or second securing device can be spaced in two directions simultaneously. Thus, the wheels lie on the inner wall of the tubular liner, but move out of the way of the radiation sources, so to speak, so that they are as far away as possible from the radiation sources and do not impede the curing of the tubular lining by means of the emitted radiation of the radiation sources. Shadowing of the tubular liner by the wheels is thus avoided and optimal curing is possible. It has thus proved to be advantageous if the support elements are arranged circularly and thus ensure a firm stop in each direction at a predefined distance of the apparatus according to the invention in the tubular liner to be cured.

Finally, the invention delivers a use of an apparatus according to the invention in a tubular liner and/or as a curing apparatus for tubular liners, in particular for curing tubular liners, preferably for curing the curable layer of the tubular liner.

Further features and advantages of the invention arise from the following description, in which exemplary embodiments of the invention are explained using schematic drawings, without thus limiting the invention.

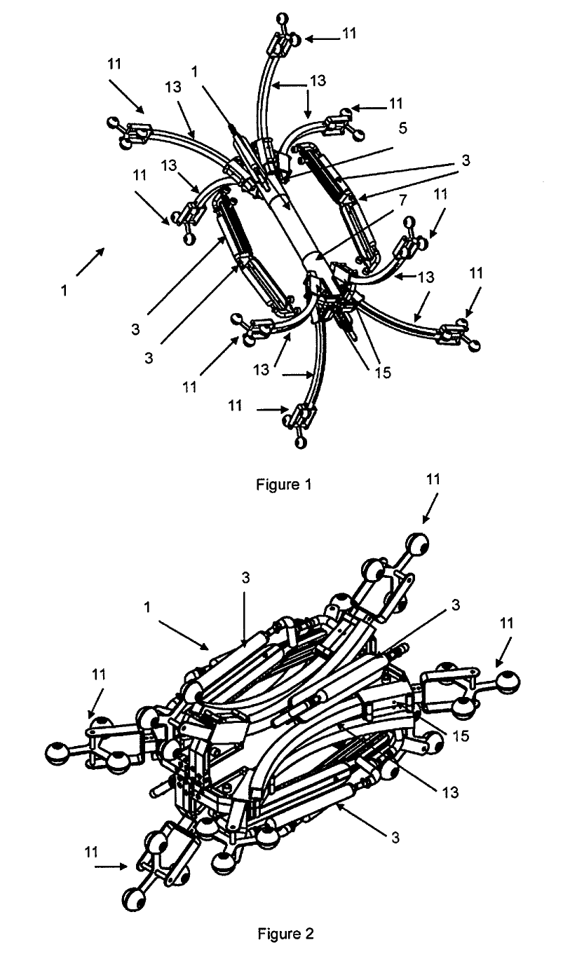

FIG. 1 shows a schematic perspective view of an apparatus according to the invention in the operating state;

FIG. 2 shows a schematic perspective view of the apparatus according to the invention from FIG. 1 in the transport state;

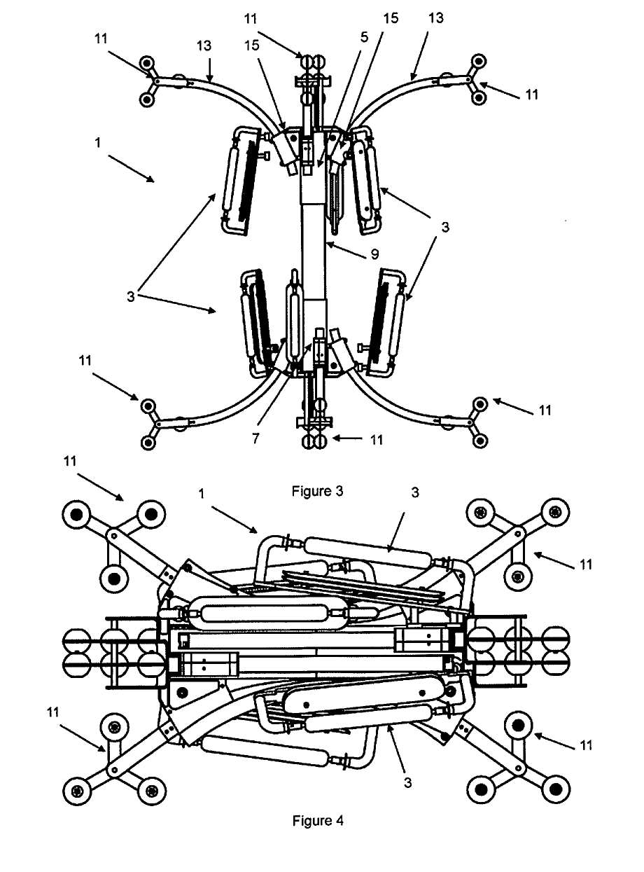

FIG. 3 shows a schematic side view of the apparatus according to the invention from FIG. 1 in the operating state;

FIG. 4 shows a schematic side view of the apparatus according to the invention from FIG. 1 in the transport state;

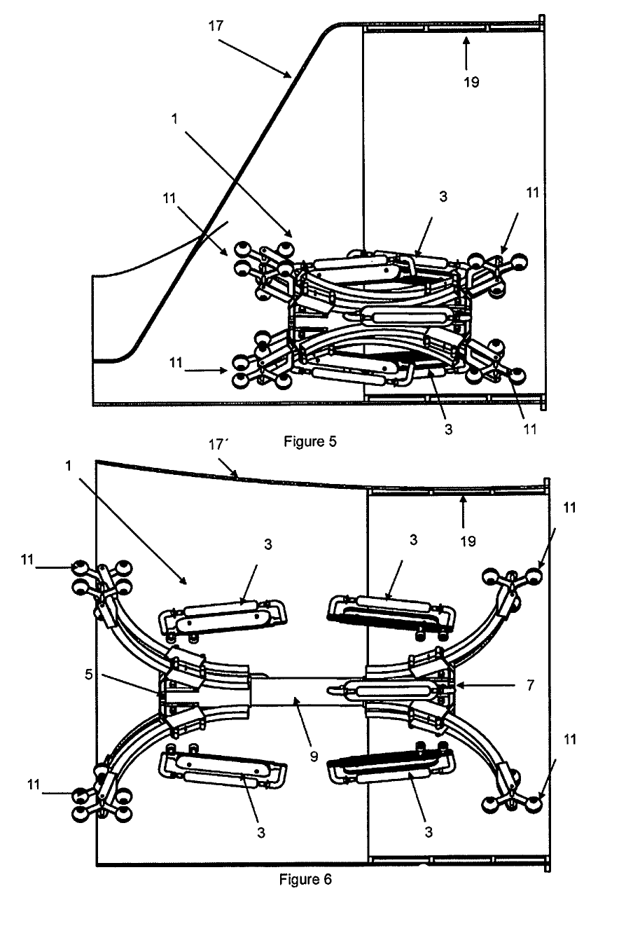

FIG. 5 shows a schematic side view of the apparatus according to the invention from FIG. 1 in the transport state in an uninflated tubular liner; and

FIG. 6 shows a schematic side view of the apparatus according to the invention from FIG. 1 in the operating state in an uninflated tubular liner

In the following, the same features are provided with the same reference numerals.

Thus, the figures show an apparatus 1 according to the invention. The apparatus 1 comprises six radiation sources 3, which are connected to a first securing device 5 and a second securing device 7 by means of spacer elements (not shown). The first securing device 5 is connected to a connecting device 9 by means of a telescopic arm, and the second securing device 7 is connected to the connecting device 9 by means of a further telescopic arm on the opposite side of said connecting device 9. The telescopic arms facilitate a linear displacement of the securing devices 5, 7 with respect to the connecting device 9 as well as against one other. It is this possible that the two securing devices 5, 7 are moved away from each other.

As can be seen in FIGS. 1, 3 and 6 in particular, the three radiation sources 3 are arranged circularly around the first and the second securing devices 5, 7, arranged displaced about a center angle α of the first and/or second securing device of 120° with respect to one another. The distance between the radiation sources 3 is fixed or variable by the spacer elements (not shown).

Thus, it can be advantageous that the radiation sources 3 (as shown) are arranged displaced about a center angle β with relation to one another, so that in the transport state these are arranged or can be arranged at least in sections, in particular parallel, overlapping. This is particularly clearly illustrated in FIG. 4.

The apparatus 1 according to the invention comprises four wheels 11 on each of the first and the second securing devices 5, 7. Each of the wheels 11 comprises three castors, which are arranged rotatably mounted about a central axis. By using the said three castors, it is also possible that a height offset within the tubular can be easily overcome. Such a height offset can occur through a coupling offset or a fold. Thus, it is discernible that support elements 13 of the wheels 11 are formed in a circular ring shape and can be inserted in the storage devices 15 arranged on each of the first and the second securing devices 5, 7 and can be passed through these. Thus, in a transition of the apparatus 1 from the transport state to the operating state, a spacing of the wheels from the securing devices 5, 7 can occur in two directions simultaneously, so that the wheels 11 do not impede the curing of the tubular liner through shadowing.

Each of the four supporting elements 13 is arranged displaced about a central angle γ of the first or second securing device 5, 7 of 90° in relation to the others. Thus, it can be ensured that the positioning of the apparatus 1 according to the invention is optimally inside the piping to be restored and guiding of the apparatus into the tubular liner is carried out from four directions.

In particular in FIGS. 5 and 6, an apparatus according to the invention is illustrated in a tubular liner to be cured. The tubular liner 17 is thus stretched over a packer 19, and in FIG. 5 illustrated in an uninflated state and in FIG. 6 in an inflated state. As shown in FIG. 5, the uninflated tubular liner 17 slopes downward until it lies double-walled on the floor. The apparatus 1 according to the invention is thus in the transport state. The first and the second securing device 5, 7 are connected to one another with a retracted telescopic arm via the connecting device 9. Thus, the radiation sources 3 are partially overlapping as these are arranged displaced from one another about the center angle β. The circular segment-shaped support elements 13 are also passed through the storage device 15 and thus reduce the size of the apparatus according to the invention.

Once the tubular liner 17′ is inflated, as shown in FIG. 6, the first and second securing devices 5, 7 are spaced from the connecting device 9 by means of an extension of the telescopic arms and the circular ring segment-shaped support elements extend so that the apparatus 1 according to the invention is in the operating state without this being damaged by the tubular liner 17, 17′.

The features of the invention disclosed in the preceding description and the claims can be essential, both individually and in any combination, to the realization of the invention in its various embodiments.

1. Apparatus for curing resin-impregnated tubular liners by means of high-energy radiation, comprising at least two radiation sources for producing high-energy radiation, wherein the apparatus has a front end, a rear end opposite the front end, two opposite side ends, an upper end and a lower end opposite the upper end, wherein a length of the apparatus, measured from the front end to the rear end, a width of the apparatus, measured from a side end to the opposite side end, and/or a height of the apparatus, measured from the lower into the upper end, is smaller in a transport state than in an operating state, in that at least one element of the apparatus is mounted such that the element can be folded out, displaced, rotated, and/or moved, and wherein at least one further radiation source is arranged to be spaced further apart from at least one further radiation source when in the operating state than in the transport state.

2. Apparatus according to claim 1, wherein a gas discharge lamp, a short-arc lamp, a stroboscopic lamp, a flash lamp, an arc lamp, in particular a xenon lamp, and/or a mercury xenon lamp is used as a radiation source, wherein in particular wherein the light source provides or can provide at least fifty percent (50%) of the radiation energy in a wavelength range of 351 to 800 nm, in particular in a range of 380 nm to 800 nm, in particular in a range of 380 nm to 700 nm, preferably in a range of 390 nm to 470 nm, or in a range of 400 nm to 800 nm.

3. Apparatus according to claim 1, wherein at least one first securing device and at least one second securing device is included, wherein the at least one first securing device is connected or can be connected to the at least one second securing device by means of at least one telescopic arm, or the at least one first securing device is connected or can be connected to a first end of at least one connecting device by means of at least one telescopic arm, and the at least one second securing device is connected or can be connected to a second end opposite the first end of the connecting device by means of at least one further telescopic arm, so that the at least one first connecting device and the at least one second connecting device can be displaced relative to one another, and in particular relative to the connecting device, preferably displaced in a linear way.

4. Closing apparatus according to claim 3, wherein at least one first radiation source, in particular n radiation sources, where n=1, 2 3, 4, 5, 6, 7, 8, 9, 10, or more, is arranged on the second securing device.

5. Closing apparatus according to claim 3, wherein the radiation sources are spaced at a first distance from the first and/or second securing apparatus, in particular n,m radiation sources are displaced circularly around the first and/or the second securing apparatus, arranged displaced about a center angle α of the first and/or second securing device of 15, 20, 30, 45, 60, 90, or 120° with respect to one another, preferably each of the 3 radiation sources are arranged displaced about a center angle α of 120° on the at least one first and the at least one second securing device.

6. Closing apparatus according to claim 1, wherein the radiation sources are connected or can be connected at a fixed distance from the at least one first and/or the at least one second securing device to these by means of spacer elements or these are arranged so that they can be folded out, displaced, rotated, and/or moved relative to the at least one first and/or the at least one second securing device by means of spacer elements, in particular by means of telescopic spacer elements.

7. Apparatus according to claim 1, wherein at least one, in particular all radiation sources of the at least one first securing device and the at least one second securing device are arranged displaced from one another about a center angle β so that in the transport state these are arranged or can be arranged at least in sections, in particular parallel, overlapping.

8. Apparatus according to claim 1, wherein the at least one first securing device and/or the at least one second securing device comprise at least one, in particular o, where o=1, 2 3, 4, 5, 6, 7, 8, 9, 10, or more, wheels, wherein at least one, in particular each of the wheels is connected or can be connected to and spaced from the at least one first and/or the at least one second securing apparatus by means of a spacer element, wherein in particular the distance of at least one, in particular all of the wheels from the first and/or second securing device in the transport state is less than in the operating state.

9. Apparatus according to claim 8, wherein the support elements are formed in a circular ring segment shape and can be inserted into or passed through a storage device arranged on each one of the at least one first and/or second securing device and/or formed by these, wherein the support elements are arranged displaced about a center angle γ of the first and/or second securing device of 15, 20, 30, 45, 60, 90, or 120° in relation to one another, preferably each of the 4 support elements are displaced about a center angle γ of 90°, on the at least one first and/or the at least one second securing device.

10. Use of an apparatus according to claim 1 in a tubular liner and/or as a curing apparatus for tubular liners, in particular for curing tubular liners, preferably for curing the curable layer of the tubular liner.
